(19) United States
(12) Patent Application Publication
(10) Pub. No.: US 2018/0311665 A1
(43) Pub. Date: Nov. 1, 2018

(54) Sample Vessel Matrix and Production Method

(71) Applicant: PerkinElmer Chemagen Technologie GmbH, Baesweiler (DE)

(72) Inventor: Lothar Å. BRASSARD, Heinsberg (DE)

(21) Appl. No.: 15/968,079

(22) Filed: May 1, 2018

Related U.S. Application Data
(63) Continuation of application No. 13/513,981, filed on Jun. 5, 2012, now abandoned.

(30) Foreign Application Priority Data
Dec. 5, 2009 (DE) 10 2009 057 223.6

(51) Int. Cl. B01L 3/00

(52) U.S. Cl. CPC B01L 3/5085; B01L 2300/0829

(57) ABSTRACT

A sample vessel matrix is provided in which the walls of the individual sample vessels are very high compared with their cross-section, wherein the ratio of the height of the sample vessel to the well length is between 3 and 7.

### CROSS-REFERENCE TO RELATED APPLICATIONS

This application is a Section 371 of International Application No. PCT/EP2010/007159, filed Nov. 25, 2010, which was published in the German language on Jun. 9, 2011, under International Publication No. WO 2011/066923 A1 and the disclosure of which is incorporated herein by reference.

### BACKGROUND OF THE INVENTION

The invention relates to a sample vessel matrix comprising a plurality of cavities having an enlarged volume, and to a production method therefor.

To examine a biological material that is in a liquid or dissolved state, the material is often filled into sample vessels in which it is then examined. These sample vessels may be present singly, but as a rule they are combined into matrices, with a plurality of such sample vessels forming a unit, which is commonly called a “plate”.

Such matrices preferably comprise a number of sample vessels that can be divided by 12, for example, 12, 24 or 96 sample vessels.

The size of the sample vessels, in particular their cross-sectional area, depends, as a rule, on the dimensions of the experimental set-up. In most cases, the cross-sectional area is several square centimeters or less.

In order to be able to produce a sample vessel matrix having such a small cross-sectional area in a simple and economical manner, a sample vessel is generally formed to be relatively flat, inter alia in an attempt to keep the sample volumes as small as possible.

This results in a limitation of the volume a sample vessel may hold, but small volumes are desirable for many applications. On the other hand, there is also the need to process large sample volumes.

Another disadvantage is that the buyer often does not perceive the proportions of such flat sample vessels as “appealing.”

### BRIEF SUMMARY OF THE INVENTION

The object underlying the present invention was to provide a sample vessel matrix that overcomes the above-mentioned disadvantages and which has a large sample volume and appealing proportions.

This object is achieved with a sample vessel matrix in which the walls of the individual sample vessels are relatively high compared with their cross-section.

The sample vessel matrix comprises a wall material. The individual sample vessels therein are formed such that when looking at the matrix from above, the sample vessels all point vertically downwards.

Preferably, the sample vessels are provided in a regular arrangement to facilitate access by machines and thereby automatic evaluation of the samples. “Regular” means that when viewing the matrix from above and subdividing its surface into quadrangles or hexagons of equal size, there is one sample in each of these quadrangles or hexagons, and that all of these subdivisions are similar to each another. These quadrangular or hexagonal subdivisions are also designated as “wells” in the following. Preferably, the matrix is provided with multiple-row rectangular wells in the form of rows and columns.

The term “well length” designates the mean value of the side lengths in the case of a quadrangular subdivision, and in the case of a hexagonal subdivision it designates the mean value of the diameters of a hexagon.

The sample vessels may have any cross-sectional area. Preferred cross-sectional areas are round, hexagonal, rectangular or square.

The sample vessels can be spaced from one another such that each vessel has its own external wall, or they may contact each other, so that the wall material of the one sample vessel is also the wall material of the other sample vessel.

“Relatively high” means that the ratio of the height of the sample vessel to the well length is between 3 and 7, preferably between 4.3 and 5.7, and especially preferably between 4.8 and 5.2.

In a preferred embodiment, a number N of sample vessels are arranged in the matrix, such that the number of columns and the number of rows correspond to those divisors of N which are closest to the square root of N. In the case of N=12 these would be 3 and 4, in the case of N=24 these would be 6 and 4, and in the case of N=96, these would be 12 and 8.

In the aforementioned preferred embodiment, the above-described ratio of the height of the sample vessel to the well length would lead to the ratio of the length to the width of the sample vessel matrix, and particularly the ratio of height to length and/or width, being within the range of the golden section, and to the proportions of the matrix being perceived as particularly appealing.

Especially preferred are embodiments in which the ratio of the length or the width of the sample vessel matrix to the height is between 1.1 and 2.1, especially preferably between 1.4 and 1.8.

Especially in the preferred case of neighboring sample vessels sharing the wall material, the increased height leads to the additional effect of an increased stiffness of the entire sample vessel matrix, compared with matrices of smaller height.

The dimension of the cross-section of a sample vessel or the well length is in the range of from 1 mm to 5 cm, preferably from 5 mm to 3 cm, especially preferably from 1.5 cm to 2 cm.

The sample vessel matrix is preferably made of a plastic material as an injection molded part. However, this causes difficulties on account of the large height of the sample vessels compared with the cross-section thereof.

Injection molding of the sample vessel matrix requires a female mold of the component part. Preferably, a metal mold is used into which liquid, hot plastic (for example polyethylene, polypropylene, polystyrene, polycarbonate) is injected at high pressure (several hundred bars).

Subsequently, the plastic is cooled down, during which process it shrinks. After that, the injection molded part must be removed from the mold without destroying the injection molded part.

To manufacture the sample vessel matrix according to the present invention, it is necessary to inject a relatively large amount of material. To permit removal, the side wall of the sample vessels must have an inclined surface. If the side wall is too oblique, volume is lost. This could be compensated by a higher side wall but this means that more material must be employed, which is not possible, however. If the side wall is not sufficiently oblique, the molded part cannot be removed.

The inventive ratio of height to well length is within a range in which such injection molding can just take place and in which the shrinking does not lead to cracks in the injection molded part, i.e. the sample vessel matrix.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic representation of the structure of a sample vessel matrix of twelve sample vessels, in plan view (left) and in side view (right), according to one embodiment of the invention.

FIG. 2 is a schematic representation of the structure of a sample vessel matrix of twenty-four sample vessels, in plan view (left) and in side view (right), according to another embodiment of the invention.

FIG. 3 is a schematic representation of the structure of a sample vessel matrix of 96 sample vessels, in plan view (left) and in side view (right), according to a further embodiment of the invention.

FIG. 4 is a schematic representation of the structure of a sample vessel matrix, wherein the side walls of the individual sample vessels comprise inclined surfaces, in side view, according to an embodiment of the invention.

FIG. 5 is a schematic representation of the structure of a sample vessel matrix, wherein the side walls of the individual sample vessels comprise inclined surfaces, in side view, according to another embodiment of the invention.

### DETAILED DESCRIPTION OF THE INVENTION

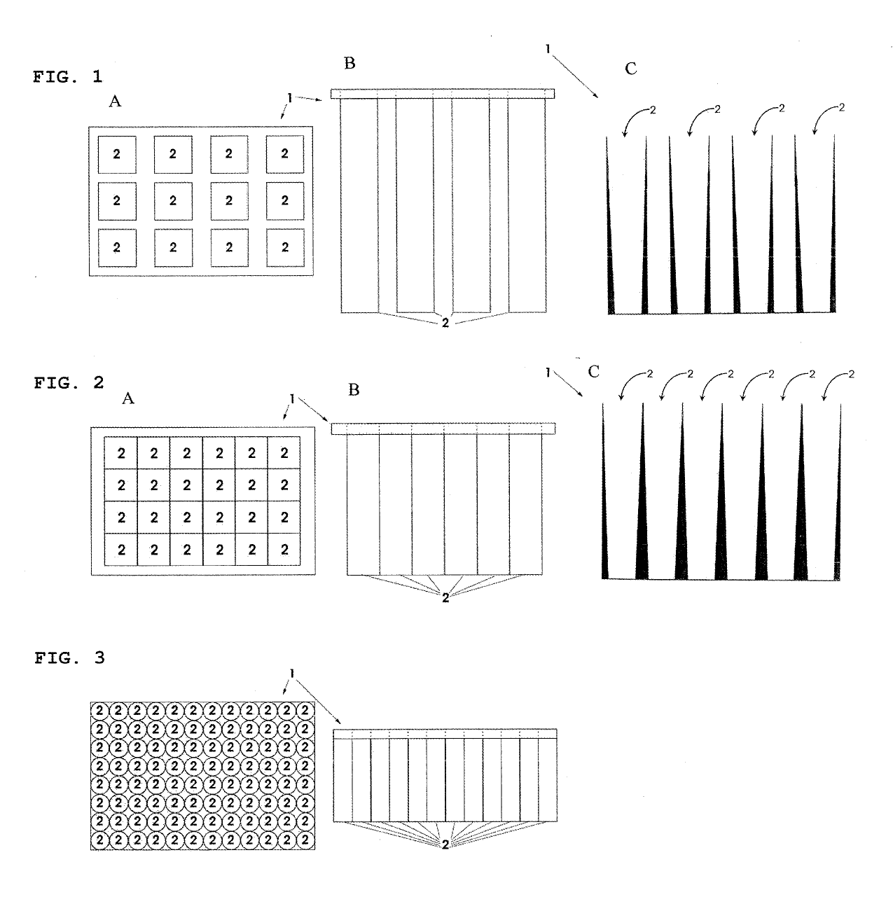

A preferred embodiment is shown in FIG. 1. The sample vessel matrix (1) comprises 12 sample vessels (2) in 3 rows by 4 columns. The sample vessels are each formed as individual vessels in the sample vessel matrix, with their walls not touching each other. The well length is 2 cm, the height is 12 cm.

Another preferred embodiment is shown in FIG. 2. The sample vessel matrix (1) comprises 24 sample vessels (2) in 4 rows by 6 columns. The sample vessels each share a wall, that is, they are contiguously formed in the sample vessel matrix. The well length is about 17.2 mm; the height is about 87.46 mm. The tolerances of these dimensions are preferably less then 10%, more preferably less than 1%, most preferably less than 0.1%. By contrast to the conventional 24-well sample vessel matrices, which have a height of around 44 mm and a cavity volume of 10 ml, these sample vessel matrices have a volumetric capacity of 25 ml. However, just like the usual sample vessel matrices, they are suited, inter alia, for the use of a magnetic separator equipped with 24 magnetizable rods (chemagic MSM I, 24 rod heat, from the company chemagen AG), which is an apparatus for isolating nucleic acids from large volumes of blood, plasma, suspensions of feces, or urine, for example.

With this sample vessel matrix it is possible to process 24 samples of 4 ml of plasma each or of 3.5 ml of blood each, in parallel, instead of 1.8 ml as hitherto.

Moreover, the sample vessel matrix is also suitable for use in the field of cell culture. Further applications are also conceivable.

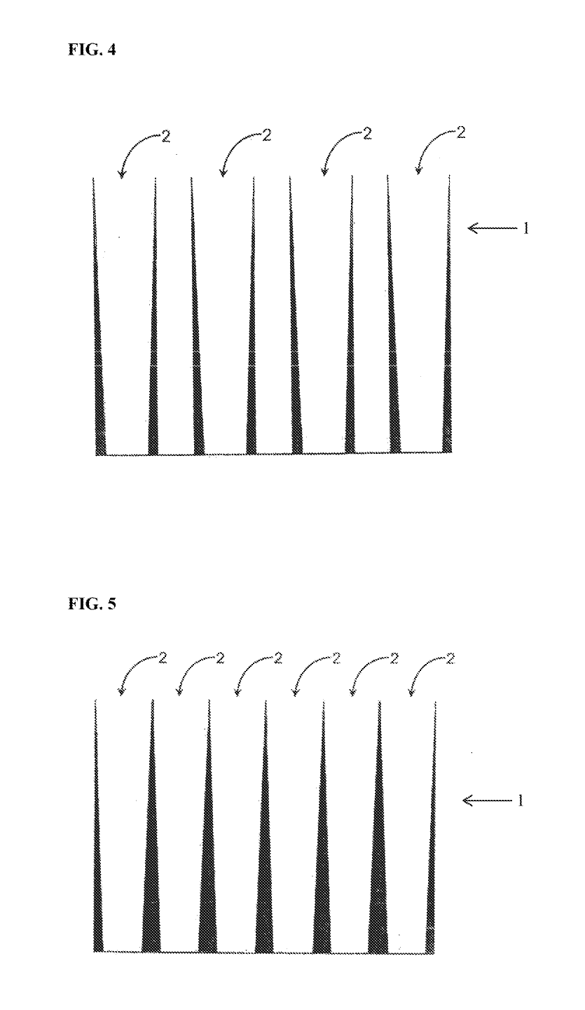

Another preferred embodiment is shown in FIG. 3. The sample vessel matrix (1) comprises 96 sample vessels (2) in 8 rows of 12 columns each. The sample vessels have a round cross-sectional surface, but do touch each other. The well length is 1 cm, the height is 5 cm.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1.-11. (cancelled)

12. A sample vessel matrix comprising a plurality of individual sample vessels having a form of fillable wells enclosed by side walls, wherein the side walls of the individual sample vessels have a well height greater than a cross-section opening of the wells, wherein a well length of the individual sample vessels measured along a side or diameter of the well opening is in a range of 1.5 cm to 2 cm, wherein a ratio of the well height of the individual sample vessels to the well length is from 4.8 to 5.2, and wherein a ratio of a length or width of the sample vessel matrix to the well height is from 1.1 to 2.1.

13. The sample vessel matrix according to claim 12, wherein the cross-section opening of the individual sample vessels has a shape selected from round, hexagonal, rectangular, and square.

14. The sample vessel matrix according to claim 12, wherein the individual sample vessels are spaced from each other such that each vessel has its own outer side wall.

15. The sample vessel matrix according to claim 12, wherein the individual sample vessels contact each other such that a side wall material of one sample vessel is also a side wall material of an adjacent sample vessel.

16. The sample vessel matrix according to claim 12, wherein the plurality N of individual sample vessels is arranged in the sample vessel matrix such that a number of columns and a number of rows of individual sample vessels correspond to those divisors of N which are closest to a square root of N.

17. The sample vessel matrix according to claim 16, wherein N is selected from 12, 24 and 96.

18. The sample vessel matrix according to claim 12, wherein the matrix is an injection molded part made of plastic material.

19. The sample vessel matrix according to claim 12, wherein the sample vessel matrix contains 96 individual sample vessels arranged in 8 rows of 12 columns each.

20. The sample vessel matrix according to claim 19, wherein adjacent individual sample vessels each share a side wall.

21. The sample vessel matrix according to claim 12, wherein the sample vessel matrix contains 24 sample vessels arranged in 4 rows of 6 columns each.

22. The sample vessel matrix according to claim 21, wherein adjacent individual sample vessels each share a side wall

23. The sample vessel matrix according to claim 12, wherein the well length is 17.2 mm and the well height is 87.46 mm, and wherein tolerances of these dimensions are preferably less than 10%.

24. The sample vessel matrix according to claim 12, wherein the side walls of the individual sample vessels comprise inclined surfaces.

25. A method of producing a sample vessel matrix according to claim 12, wherein the sample vessel matrix is produced as an injection molded part from a plastic material injected into a female mold of the sample vessel matrix.

26. The method according to claim 25, wherein the plastic is injected into the female mold in liquid, hot form at high pressure, and wherein the injection molded part, after cooling of the plastic material, is removed from the mold.
